(19) United States
(12) Patent Application Publication
(10) Pub. No.: US 2015/0095553 A1
(43) Pub. Date: Apr. 2, 2015

(54) SELECTIVE SOFTWARE-BASED DATA COMPRESSION IN A STORAGE SYSTEM BASED ON DATA HEAT

(71) Applicant: INTERNATIONAL BUSINESS MACHINES CORPORATION, Armonk, NY (US)

(72) Inventor: ANDREW D. WALLS, SAN JOSE, CA (US)

(73) Assignee: INTERNATIONAL BUSINESS MACHINES CORPORATION, Armonk, NY (US)

(21) Appl. No.: 14/043,522

(22) Filed: Oct. 1, 2013

(51) Int. Cl. G06F 3/06; G06F 12/02

(52) U.S. Cl. CPC G06F 3/0613; G06F 12/0246; G06F 3/0679; G06F 3/0629
USPC 711/103

(57) ABSTRACT

In a data storage system, in response to receipt from a processor system of a write input/output operation (IOP) including an address and data, a storage controller of the data storage system determines whether or not the address is a hot address that is more frequently accessed. In response to determining that the address is a hot address, the storage controller stores the data in the data storage system in uncompressed form. In response to determining that the address is not a hot address, the storage controller compresses the data to obtain compressed data and stores the compressed data in the data storage system.

### BACKGROUND OF THE INVENTION

The present invention relates to data storage, and more specifically, to data storage systems employing software-based data compression.

Data compression has conventionally been employed to increase the effective storage capacity of data storage systems. As processors have become more powerful and the number of processor cores per socket have increased, some data storage systems have employed software-based data compression as an inexpensive way to increase effective storage capacity. In software-based data compression, a processor at the data storage system executes compression software to compress all data written to the storage resources of the data storage system and to decompress all data read from the storage resources. Use of software-based data compression has been particularly successful in data storage system utilizing hard disk drive (HDD) storage, where data throughput and the rate of input/output operations (IOPs) tend to be relatively low.

As the demand for storage system performance has increased, the industry has shown increased interest in employing higher speed storage technologies, such as flash memory and solid state disks (SSDs), as the bulk storage media of data storage systems. Since SSDs generally cost more than HDDs, compression can increase how much is stored on a relatively expensive media, therefore decreasing the cost per gigabyte (GB). However, the present invention recognizes that implementation of software-based data compression places the processor of the data storage system in the critical timing path of every read and write access in order to compress data written to the data storage system and decompress data read from the data storage system. Consequently, the present invention recognizes that software-based compression can create a bottleneck at the processor that throttles back performance, increases response time and reduces the advantage of implementing higher speed storage technologies, such as flash memory and SSDs, in data storage systems.

### BRIEF SUMMARY

Disclosed herein are techniques to selectively perform software-based compression of data in a data storage system to achieve good overall compression while significantly increasing storage system performance. As described further herein, the software-based compression can be selectively applied based on the heat (i.e., relative frequency of access) of the data.

In some embodiments of a data storage system, in response to receipt from a processor system of a write input/output operation (IOP) including an address and data, a storage controller of the data storage system determines whether or not the address is a hot address that is more frequently accessed. In response to determining that the address is a hot address, the storage controller stores the data in the data storage system in uncompressed form. In response to determining that the address is not a hot address, the storage controller compresses the data to obtain compressed data and stores the compressed data in the data storage system.

### BRIEF DESCRIPTION OF THE SEVERAL VIEWS OF THE DRAWINGS

FIG. 1 is a high level block diagram of a data processing environment in accordance with one embodiment;

FIG. 2 is a high level logical flowchart of an exemplary method by which a data storage system determines a dynamically variable percentage of the “hottest” addresses for which the associated data will not be compressed by the data storage subsystem;

FIG. 3 is a high level logical flowchart of an exemplary method of selectively performing software-based data compression in a data storage system based on data heat; and

FIG. 4 illustrates an exemplary temperature data structure (TDS) in accordance with one embodiment.

### DETAILED DESCRIPTION

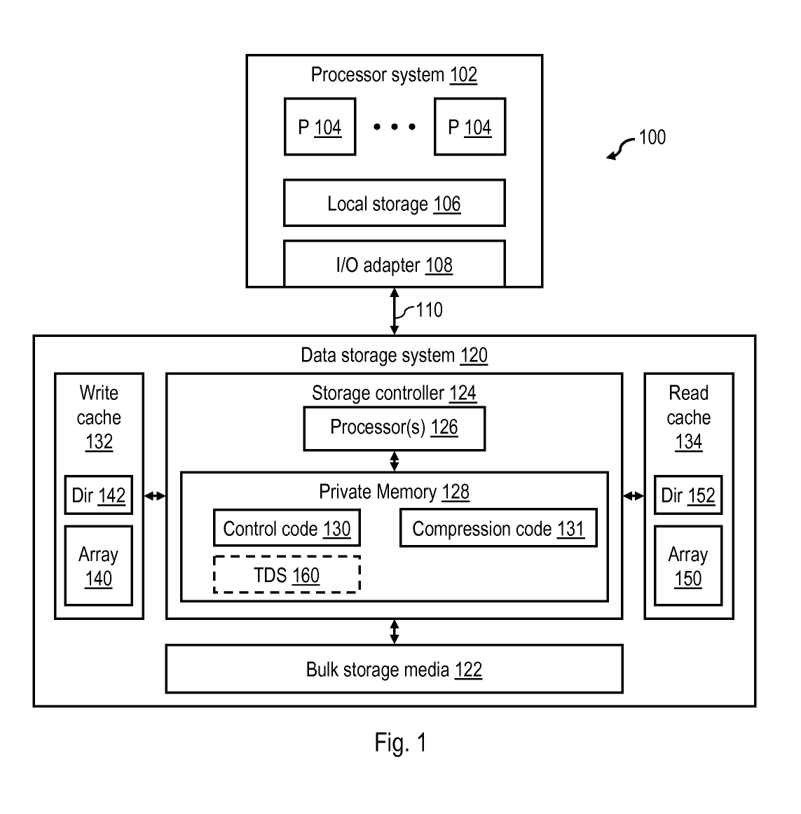

With reference now to the figures and with particular reference to FIG. 1, there is illustrated a high level block diagram of an exemplary data processing environment 100 including a data storage system that implements selective software-based compression of data, as described further herein. As shown, data processing environment 100 includes at least one processor system 102 having one or more processors 104 that process instructions and data. Processor system 102 may additionally include local storage 106 (e.g., dynamic random access memory (DRAM) or disks) that may store program code, operands and/or execution results of the processing performed by processor(s) 104. In various embodiments, processor system 102 can be, for example, a mobile computing device (such as a smartphone), a laptop or desktop personal computer system, a server computer system (such as one of the POWER series available from International Business Machines Corporation), or a mainframe computer system.

Processor system 102 further includes an input/output (I/O) adapter 108 that is coupled directly (i.e., without any intervening device) or indirectly (i.e., through at least one intermediate device) to a data storage system 120 via an I/O channel 110. In various embodiments, I/O channel may employ any one or a combination of known or future developed communication protocols, including, for example, Fibre Channel (FC), FC over Ethernet (FCoE), Internet Small Computer System Interface (iSCSI), Transport Control Protocol/Internet Protocol (TCP/IP), etc. I/O operations (IOPs) communicated via I/O channel 110 include read IOPs by which processor system 102 requests data from data storage system 120 and write IOPs by which processor system 102 requests storage of data in data storage system 120.

Data storage system 120 includes bulk storage media 122, which typically provide a storage capacity much greater than the local storage 106 of processor system 102. Bulk storage media 122 is typically implemented with non-volatile storage media, such as magnetic disks, flash memory, SSDs, phase change memory (PCM), etc. Depending on the size and configuration of the data storage system 120, bulk storage media 122 can be physically located fully or partially inside the same enclosure as the remainder of data storage system 120 or can be located externally in one or more separate enclosures. Read and write access to the contents of bulk storage media 122 by processor system 102 is controlled by a storage controller 124. In at least one embodiment, storage controller 124 implements software control of data storage system 120. Accordingly, FIG. 1 illustrates an embodiment of storage controller 124 that includes a private memory 128 storing control code 130, as well as one or more processors 126 that execute control code 130 from private memory 128 to control data storage system 120. Private memory 128 additionally includes compression code 131 that the one or more processors 126 execute to implement selective software-based compression of data written by processor system 102 to data storage system 120, as disclosed further herein.

Because the storage technology selected to implement bulk storage media 122 generally has a higher access latency than other available storage technologies, data storage system 120 often includes a lower latency write cache 132 that caches data written by processor system 102 to data storage system 120. Write cache 132 includes an array 140 for storing write data, as well as a directory 142 indicating at least the addresses of the data currently held in array 140. In at least some embodiments, write cache 132 may be software-managed through the execution of control code 130 by storage controller 124 in order to intelligently and selectively cache write data of write IOPs received from processor system 102 to ensure that write caching is implemented in a manner that improves (rather than diminishes) a desired performance metric of data storage system 120.

As further shown in FIG. 1, data storage system 120 may optionally further include a read cache 134 that caches data likely to be read from bulk storage media 122 by processor system 102. Read cache 134 includes an array 150 for storing read data, and a directory indicating at least the addresses of the contents of array 150. Write cache 132 and read cache 134 may be implemented, for example, in DRAM, SRAM, or PCM.

It should be noted that in some embodiments of data processing environment 100 more than one processor system 102 can access a single data storage system 120. Also, in some embodiments, data storage system 120 can be implemented as part of local storage 106. In yet other embodiments, storage controller 124 and write cache 132 of data storage system 120 can be implemented as part of local storage 106 and bulk storage media 122 can be externally attached via I/O channel 110.

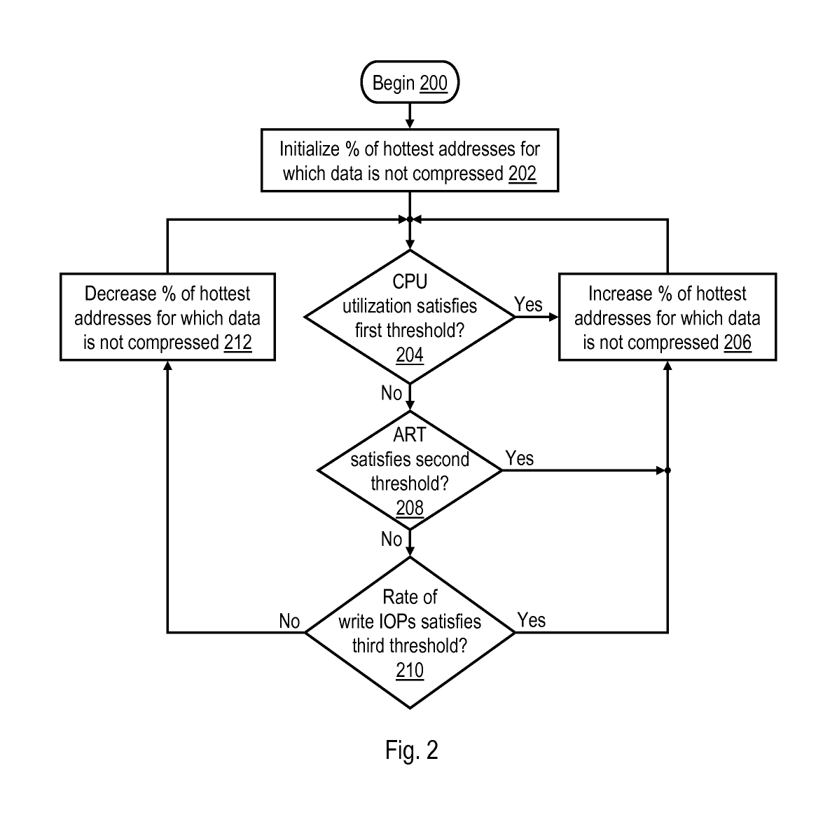

Referring now to FIG. 2, there is depicted a high level logical flowchart of an exemplary method by which a data storage system determines a variable percentage of the “hottest” addresses for which the associated data will not be compressed by data storage system 120. The process of FIG. 2 is preferably performed by storage controller 124 through the execution of control code 130. In alternative embodiments, the functions of control code 130 may be partially or fully implemented in hardware, such as a field programmable gate array (FPGA) or application specific integrated circuit (ASIC).

The illustrated process begins at block 200 and thereafter proceeds to block 202, which depicts storage controller 124 initializing a certain percentage of the most frequently accessed (i.e., “hottest”) addresses in the I/O address space employed by data storage system 120 for which software-based data compression will not be performed by storage controller 124. This initialization step can be performed, for example, as part of the boot process of data storage system 120. Although the initial percentage established at block 202 may vary widely between embodiments depending, for example, on the number and performance of processor(s) 126, the desired average response time (ART) of data storage system 120 for a certain IOP workload, and on the expected rate of receipt of IOPs, in at least some embodiments the initial percentage established at block 202 is approximately the hottest 10% of addresses in the I/O address space. The initialized value may be set for an entire population of data storage systems and/or may be based on a historical average for this data storage system. Further, it should be appreciated that the size of the storage granules associated with these addresses can vary between embodiments, and in some implementations, can be dynamically configurable, for example, through execution of control code 130. For example, the size of the storage granules can be 64 kB, 256 kB, 1 MB, 100 MB, etc.

Following the initialization at block 202, the process proceeds to a processing loop including blocks 204-212 in which storage controller 124 dynamically varies the percentage of hottest addresses for which software-based data compression is performed during operation of data storage system 120 (i.e., while data storage system 120 is servicing read and write IOPs received from processor system 102). In the embodiment shown in FIG. 2, storage controller 124 varies the percentage based on one or more performance criteria that storage controller 124 continually monitors. In various embodiments, the processing loop comprising blocks 204-212 can be performed, for example, at fixed intervals or in response to one or more performance criteria, such as CPU utilization of processor(s) 126, satisfying one or more thresholds.

Referring now to block 204, storage controller 124 determines whether the current CPU utilization of processor(s) 126 satisfies a first threshold. For example, in at least some embodiments, the determination depicted at block 204 determines if the average CPU utilization processor(s) 126 is greater than or equal to a first threshold, such as 50%. In response to a negative determination at block 204, the process proceeds to block 208, which is described below. However, in response to storage controller 124 determining at block 204 that the CPU utilization of processor(s) 126 satisfies the first threshold, the process proceeds to block 206.

Block 206 depicts storage controller 124 increasing the current percentage of hottest addresses for which data is not compressed by compression code 131. In various embodiments, storage controller 124 can increase the percentage at block 206 by a fixed or configurable amount, and further, can vary the amount of increase based on one or more performance criteria, including the CPU utilization of storage controller 124, ART, rate of receipt of write IOPs, etc. As a consequence of the increase made at block 206, storage controller 124 performs software-based data compression (through execution of compression code 131) for the storage data of fewer write IOPs, which not only directly reduces processor utilization, but also has the concomitant effects of reducing software-based data compression during deduplication and garbage collection in flash memory and of reducing software-based data decompression of the read data requested by read IOPs. Following block 206, the process of FIG. 2 returns to block 204, which has been described.

Referring now to block 208, storage controller 124 determines whether or not the average response time (ART) of data storage system 120 over a current (or recent) time interval satisfies (e.g., is greater than or equal to) a second threshold. In various embodiments, the ART employed in the determination at block 208 can be the ART of data storage system 120 in response to only a subset of IOPs (e.g., all write IOPs or all read IOPs) or in response to all IOPs. In response to a negative determination at block 208, the process proceeds to block 210, which is described below. However, in response to storage controller 124 determining at block 208 that the ART of data storage system 120 satisfies the second threshold, the process passes to block 206, which has been described.

With reference now to block 210, storage controller 124 determines whether or not the rate of receipt by data storage system 120 of write IOPs (i.e., the IOPs for which software-based data compression is potentially performed) from processor system 102 satisfies (e.g., is greater than or equal to) a third threshold. If so, the process passes to block 206, which has been described. If, on the other hand, storage controller 124 determines at block 210 that the rate of receipt of write IOPs does not satisfy the third threshold, the process passes to block 212. Block 212 illustrates storage controller 124 decreasing the current percentage of hottest addresses for which software-based data compression is not performed by compression code 131 (i.e., increasing the current percentage of addresses for which software-based data compression is performed by compression code 131). In various embodiments, storage controller 124 can decrease the percentage at block 212 by a fixed or configurable amount, and further, can vary the amount of increase based on one or more performance criteria, including the CPU utilization of storage controller 124, ART, rate of receipt of write IOPs, etc. Another criterion that may be used in some embodiments is whether an average response time has exceeded a threshold for an interval like five minutes. As a consequence of the decrease made at block 212, storage controller 124 performs software-based data compression (through execution of compression code 131) for the store data of more write IOPs, which not only directly increases processor utilization, but also has the concomitant effects of increasing software-based data compression during deduplication and garbage collection in flash memory and of increasing software-based data decompression of the read data requested by read IOPs. Following block 212, the process of FIG. 2 returns to block 204, which has been described.

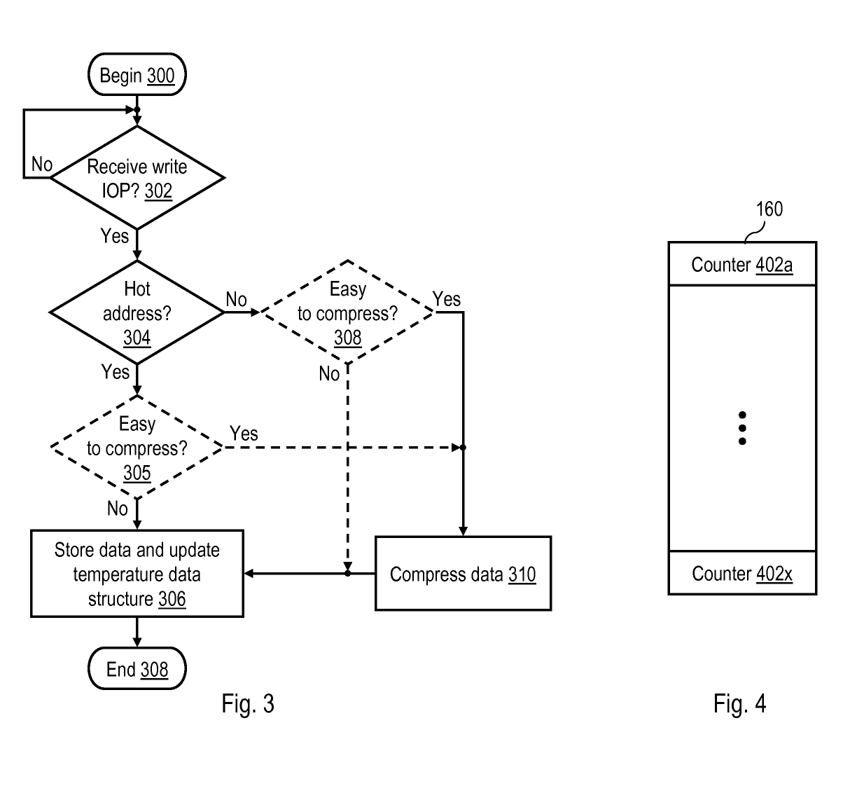

With reference now to FIG. 3, there is a high level logical flowchart of an exemplary method of selectively performing software-based data compression in a data storage system, such as data storage system 120, based on data heat. The illustrated process can be performed, for example, through the execution of control code 130 and the selective execution of compression code 131 by processor(s) 126 of storage controller 124. As noted above, in other embodiments, the illustrated process may be partially or fully implemented in hardware.

The process of FIG. 3 begins at block 300 and then proceeds to block 302, which illustrates storage controller 124 awaiting receipt of a write IOP from processor system 102. As shown, the process of FIG. 3 iterates at block 302 until storage controller 124 determines that it has received a write IOP from processor system 102 and, responsive thereto, proceeds to block 304. As those skilled in the art will realize, many IOPs can be received concurrently, so block 302 will be entered immediately in the event that there is a queue of write IOPs. Also, some embodiments will have multiple threads executing the process of FIG. 3 concurrently. At block 304 storage controller 124 determines whether or not the address specified by the write IOP is a “hot” address, defined herein to mean an address within the current percentage of most frequently accessed addresses for which storage controller 124 does not perform software-based data compression.

In one embodiment, storage controller 124 can make the determination depicted at block 304 by reference to an optional temperature data structure (TDS) 160 residing, for example, in private memory 128. As shown in FIG. 4, in this embodiment, TDS 160 may be implemented, for example, as a table or other data structure including a plurality of counters 402a-402x each associated with a respective one of plurality of storage granules in the I/O address space of data storage system 120. In this embodiment, storage controller 124 simply advances each counter 402 in TDS 160 in response to receipt of each read or write IOP specifying an address that maps to the associated storage granule and resets all counters 402 at the beginning of each monitoring interval (e.g., each hour) or in response to an overflow of any of the counters 402. Thus, in this embodiment, storage controller 124 determines at block 304 whether or not the target address specified the write IOP received at block 302 identifies a storage granule for which the associated counter in TDS 160 has one of the highest M % of counter values (where M represents the current percentage established by the process of FIG. 2).

In one or more alternative embodiments, TDS 160 can be omitted, and storage controller 124 can make the determination illustrated at block 304 by reference to one or more of directories 142 and 152. For example, storage controller 124 can determine at block 304 whether the address specified by the write IOP received at block 302 hits in one or both of cache directories 142 and 152. As a further refinement, storage controller 124 may further restrict the hit determination to only the N most recently referenced ways of a congruence class to which the target address maps, as indicated, for example, by replacement order vectors maintained in cache directories 142 and/or 152. Storage controller 124 may further determine the number N utilizing the process of FIG. 2, where each step up or down in the percentage M corresponds to the addition or removal of a more recently used way of cache memory from consideration in the determination made at block 304.

Regardless of the implementation of the determination of whether the target address of the write IOP is a hot address, in some embodiments the process proceeds from block 304 directly to block 306 in response to storage controller 124 determining at block 304 that the target address is a hot address. In some alternative embodiments, storage controller 124 first determines at block 305 (e.g., by history, data type, or quick examination of a sample of the write data) that the write data is highly compressible and will therefore require very little processor execution time to compress. As an example, highly compressible data can include data pages containing all zeros, sparsely populated tables, or other data. In response to a determination at block 305 that the write data is not highly compressible, the process proceeds to block 306, which is described below. However, in response to a determination at block 305 that the write data is highly compressible, the process passes block 310, which, as described below, illustrates storage controller 124 compressing the write data.

When the process proceeds from block 304 or 305 to block 306, storage controller 124 directs the storage of the data of the write IOP in data storage system 120 (i.e., in write cache 132 or bulk storage medium 122), in this case in uncompressed form. In addition, storage controller 124 updates one or more data structures to reflect the dynamic “temperature” or “heat” of the target address of the write IOP, for example, by advancing the relevant counter 402 in TDS 160 and/or updating the appropriate replacement order vector in write cache 132. As will be appreciated, as the “heat” or “temperature” of various addresses is updated in response to the access patterns of IOPs, the set of addresses that are compressed (and the set of addresses that are not compressed) will vary dynamically over time and will do so independently of the dynamically varying percentage of addresses for which software-based compression is performed (as determined by the process of FIG. 2). Thereafter, the process of FIG. 3 ends at block 308.

Returning to block 304, in response to a determination that the target address specified by the write IOP is not a hot address, the process either passes directly to block 310, or in alternative embodiments, first passes to optional block 308. At block 308, storage controller 124 determines whether or not the data specified by the write IOP are easy to compress. The determination depicted at block 308 can include an examination of a file type indicated by the write IOP or by the encoding of the write data itself to determine whether or not the write data forms at least a portion of a file type that is known to be difficult to substantially compress (e.g., a Portable Document Format (PDF) file, one of the Joint Photographic Experts Group (JPEG) file formats, another media file format, etc.). Alternatively or additionally, the determination depicted at block 308 can further include an estimation of the compressibility of the write data, which may entail executing compression code 131 to compress a small sample of the write data or to measure the randomness of the write data.

In any case, if optional block 308 is implemented, in response to a determination that the write data is not easily compressible, the process passes to block 306, and storage controller 124 stores the write data in data storage system 120 in uncompressed form and updates a temperature data structure, as previously described. However, if block 308 is omitted or in response to a determination at block 308 that the write data are easily compressible, storage controller 124 executes compression code 131 to compress the write data of the write IOP. Thereafter, storage controller 124 stores the compressed data within data storage system 120 and updates a temperature data structure, as shown at block 306. Following block 306, the process of FIG. 3 ends at block 308.

As has been described, in some embodiments of a data storage system, in response to receipt from a processor system of a write input/output operation (IOP) including an address and data, a storage controller of the data storage system determines whether or not the address is a hot address that is more frequently accessed. In response to determining that the address is a hot address, the storage controller stores the data in the data storage system in uncompressed form. In response to determining that the address is not a hot address, the storage controller compresses the data to obtain compressed data and stores the compressed data in the data storage system.

While the present invention has been particularly shown as described with reference to one or more preferred embodiments, it will be understood by those skilled in the art that various changes in form and detail may be made therein without departing from the spirit and scope of the invention. For example, although aspects have been described with respect to a computer system executing program code that directs the functions of the present invention, it should be understood that present invention may alternatively be implemented as a program product including a storage device (e.g., memory, magnetic disk, DVD, CD-ROM, etc.) storing program code that can be processed by a processor to direct the described functions. As employed herein the term “storage device” is defined to exclude transitory propagating signals per se.

What is claimed is:

1. A method of storage management in a data storage system, the method comprising:
in response to receipt from a processor system of a write input/output operation (IOP) including an address and data, a storage controller of the data storage system determining whether or not the address is a hot address that is more frequently accessed;
in response to determining that the address is a hot address, the storage controller storing the data in the data storage system in uncompressed form; and
in response to determining that the address is not a hot address, the storage controller compressing the data to obtain compressed data and storing the compressed data in the data storage system.

2. The method of claim 1, and further comprising:
the storage controller further determining whether or not the data is easily compressed;
in response to determining that the data is easily compressed, performing the compressing; and
in response to determining that the data is not easily compressed, refraining from compressing the data and storing the data in the data in the data storage system in uncompressed form.

3. The method of claim 1, and further comprising the storage controller varying a percentage of addresses in an address space of the data storage device that are hot addresses in response to one or more performance criteria.

4. The method of claim 3, wherein the one or more performance criteria include one or more of a set including a CPU utilization of the storage controller, an average response time of the data storage system and a rate of receipt of write IOPs.

5. The method of claim 4, wherein:
the varying includes increasing the percentage of addresses that are hot addresses for which data is stored in the data storage system in uncompressed form in response to CPU utilization satisfying a threshold, regardless of values of any other performance criteria.

6. The method of claim 3, and further comprising the storage controller varying which of the addresses are hot addresses based on IOPs requesting read and write access to the addresses that are received by the data storage system.

7. A storage controller for a data storage system, comprising:
a processor; and
memory coupled to the processor, wherein the memory includes program code that when processed by the processor, causes the storage controller to:
in response to receipt from a processor system of a write input/output operation (IOP) including an address and data, determine whether or not the address is a hot address that is more frequently accessed;
in response to determining that the address is a hot address, store the data in the data storage system in uncompressed form; and
in response to determining that the address is not a hot address, compress the data to obtain compressed data and storing the compressed data in the data storage system.

8. The storage controller of claim 7, wherein the program code, when processed by the processor, causes the storage controller to:
determine whether or not the data is easily compressed;
in response to determining that the data is easily compressed, compress the data; and
in response to determining that the data is not easily compressed, refrain from compressing the data and store the data in the data in the data storage system in uncompressed form.

9. The storage controller of claim 7, wherein the program code, when processed by the processor, causes the storage controller to:
vary a percentage of addresses in an address space of the data storage device that are hot addresses in response to one or more performance criteria.

10. The storage controller of claim 9, wherein the one or more performance criteria include one or more of a set including a CPU utilization of the storage controller, an average response time of the data storage system and a rate of receipt of write IOPs.

11. The storage controller of claim 10, wherein:
the storage controller varies the percentage of addresses by increasing the percentage of addresses that are hot addresses for which data is stored in the data storage system in uncompressed form in response to CPU utilization satisfying a threshold, regardless of values of any other performance criteria.

12. The storage controller of claim 9, wherein the program code, when processed by the processor, causes the storage controller to:
vary which of the addresses are hot addresses based on IOPs requesting read and write access to the addresses that are received by the data storage system.

13. A data storage system, comprising:
the storage controller of claim 9; and
bulk storage media.

14. The data storage system of claim 14, wherein the bulk storage media comprises non-volatile memory.

15. A program product for a storage controller of a data storage system, the program product comprising:
a storage device; and
program code stored within the data storage device, that when processed by a storage controller, causes the storage controller to:
in response to receipt from a processor system of a write input/output operation (IOP) including an address and data, determine whether or not the address is a hot address that is more frequently accessed;
in response to determining that the address is a hot address, store the data in the data storage system in uncompressed form; and
in response to determining that the address is not a hot address, compress the data to obtain compressed data and storing the compressed data in the data storage system.

16. The program product of claim 15, wherein the program code, when processed by the processor, causes the storage controller to:
determine whether or not the data is easily compressed;
in response to determining that the data is easily compressed, compress the data; and
in response to determining that the data is not easily compressed, refrain from compressing the data and store the data in the data in the data storage system in uncompressed form.

17. The program product of claim 15, wherein the program code, when processed by the processor, causes the storage controller to:
vary a percentage of addresses in an address space of the data storage device that are hot addresses in response to one or more performance criteria.

18. The program product of claim 17, wherein the one or more performance criteria include one or more of a set including a CPU utilization of the storage controller, an average response time of the data storage system and a rate of receipt of write IOPs.

19. The program product of claim 18, wherein:
the storage controller varies the percentage of addresses by increasing the percentage of addresses that are hot addresses for which data is stored in the data storage system in uncompressed form in response to CPU utilization satisfying a threshold, regardless of values of any other performance criteria.

20. The program product of claim 17, wherein the program code, when processed by the processor, causes the storage controller to:
vary which of the addresses are hot addresses based on IOPs requesting read and write access to the addresses that are received by the data storage system.
